(19) United States
(12) Patent Application Publication
(10) Pub. No.: US 2026/0256329 A1
(43) Pub. Date: Sep. 3, 2026

(54) LINKAGE COVER STRUCTURE FOR INCINERATION TOILETS

(71) Applicant: Guangdong Mory Intelligent Technology Co.,Ltd., Foshan (CN)

(72) Inventors: Dan HUANG, Foshan (CN); Sirong LIANG, Foshan (CN)

(21) Appl. No.: 19/655,660

(22) Filed: Apr. 22, 2026

Related U.S. Application Data
(63) Continuation of application No. PCT/CN2024/100421, filed on Jun. 20, 2024.

(30) Foreign Application Priority Data
Jan. 30, 2024 (CN) 202410123317.8

(51) Int. Cl. A47K 13/26; A47K 11/02

(52) U.S. Cl. CPC A47K 13/26; A47K 11/023

(57) ABSTRACT

The present invention relates to a linkage cover structure for incineration toilets, which at least comprises a buffer structure, an incineration structure, and a bracket; the buffer structure comprises a release component and a buffer component, and the buffer component is provided with a buffer tank and a release port; the incineration structure comprises an incineration sealing component and an incineration bucket with a top opening, a receiving section is provided on the top of the incineration bucket, and both the buffer component and the incineration bucket are provided on the bracket. The effect achieved by the present invention is to reduce odor, facilitate cleaning, save water and energy, protect the environment, and ensure hygiene and safety.

### TECHNICAL FIELD

The present invention relates to the field of waterless toilet technology, particularly to a linkage cover structure for incineration toilets.

### BACKGROUND ART

CN112020319A discloses an incineration toilet with a lifting device, comprising a toilet unit, which comprises a toilet bowl, an incineration chamber, and an ash tray; a toilet housing, which is arranged so that it covers at least part of the toilet unit; and a lifting device, which is arranged to move the toilet housing relative to the toilet unit from a first position, in which the toilet housing covers at least part of the toilet unit, to a second position, which allows access to at least part of the toilet unit. The lifting device comprises a spring-loaded device, which is suitable for storing mechanical energy in the first position, so as to provide a pushing or pulling force when actuated for moving the toilet housing from the first position to the second position.

The prior art has at least the following technical problems: the incineration cylinder has to be removed for cleaning, which is inconvenient to use; the toilet has a large volume due to restriction by the flip-up structure; there is room for further improvement in terms of sealing effect, load-bearing capacity, reliability, mass production, etc.

### SUMMARY OF THE INVENTION

One objective of the present invention is to solve or alleviate the above technical problems.

The method adopted by the present invention is a linkage cover structure for incineration toilets, which at least comprises a buffer structure, an incineration structure, and a bracket; the buffer structure comprises a release component and a buffer component, and the buffer component is provided with a buffer tank and a release port; the incineration structure comprises an incineration sealing component and an incineration bucket with a top opening, a receiving section is provided on the top of the incineration bucket, and both the buffer component and the incineration bucket are provided on the bracket; when viewed from above, the release port partly overlaps with the top opening of the incineration bucket; the release component is hinged to the buffer component and fully covers the release port; the incineration sealing component is hinged to the incineration bucket and fully covers the top opening of the incineration bucket; the incineration bucket also comprises an incineration section located below the receiving section, and the incineration section is provided with a heating component; both the release component and the incineration sealing component have rotational power.

The effect achieved by the present invention is to reduce odor, facilitate cleaning, save water and energy, protect the environment, and ensure hygiene and safety.

A further technical solution, wherein the trajectory formed by the rotation of the other end of the release component has a portion that is lower than the top of the incineration bucket.

A further technical solution, wherein it further comprises a rotational power device, the release component is fixedly provided with a release component shaft, and the release component shaft is hinged to the bracket; the incineration sealing component is lower than the top of the incineration bucket, so that the incineration sealing component is located inside the incineration bucket, and the incineration sealing component shaft extends out of the incineration bucket snugly and is hinged to the bracket, and the rotational output end of the rotational power device is connected to at least one of the release component shaft and the incineration sealing component shaft.

There are two layers of separation between the buffer tank and the incineration bucket, which is conducive to keeping the buffer tank clean.

A further technical solution, wherein the rotational direction of the release component when it is opened is the same as that of the incineration sealing component when it is opened.

This technical solution can reduce the probability of the wax paper, the excreta thereon, etc. coming into contact with the top surface of the incineration sealing component.

A further technical solution, wherein the power structure further comprises a linkage component, a release component shaft is fixed with a release component wheel having rotational power, the incineration sealing component shaft is fixed with an incineration sealing component wheel having rotational power, and the linkage component is connected to the release component wheel and the incineration sealing component wheel respectively, so that the release component wheel and the incineration sealing component wheel are linked, and the angular velocity of the release component wheel is less than that of the incineration sealing component wheel during rotation.

A further technical solution, wherein both the release component wheel and the incineration sealing component wheel are chain wheels, the number of teeth of the incineration sealing component wheel is less than that of the release component wheel, and the linkage component is a chain that bypasses both the release component wheel and the incineration sealing component wheel.

This technical solution can reduce the overall height of the toilet and achieve miniaturization.

A further technical solution, wherein when both the release component and the incineration sealing component are sealed, the release component is arranged to tilt downward, and the incineration sealing component is arranged horizontally.

This technical solution can reduce the probability of the wax paper, the excreta thereon, etc. coming into contact with the top surface of the incineration sealing component.

A further technical solution, wherein when the incineration sealing component member rotates to open to press against the inner wall of the incineration bucket, the release component is arranged to tilt downward, and the incineration sealing component member is completely located inside a vertical plane passing through the other end of the release component.

This technical solution can prevent the wax paper, the excreta thereon, etc. from coming into contact with the top surface of the incineration sealing component, and keep the top surface of the incineration sealing component clean.

### BRIEF DESCRIPTION OF THE DRAWINGS

FIG. 1 is three-dimensional schematic diagram 1 of the incineration toilet in an embodiment of the present invention.

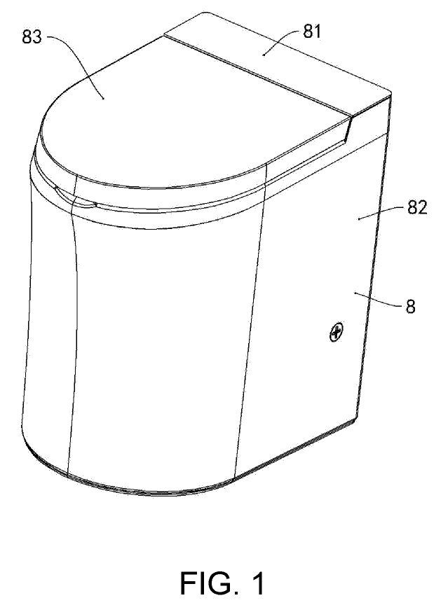

FIG. 2 is three-dimensional exploded view 1 of the incineration toilet in an embodiment of the present invention.

FIG. 3 is three-dimensional exploded view 2 of the incineration toilet in an embodiment of the present invention.

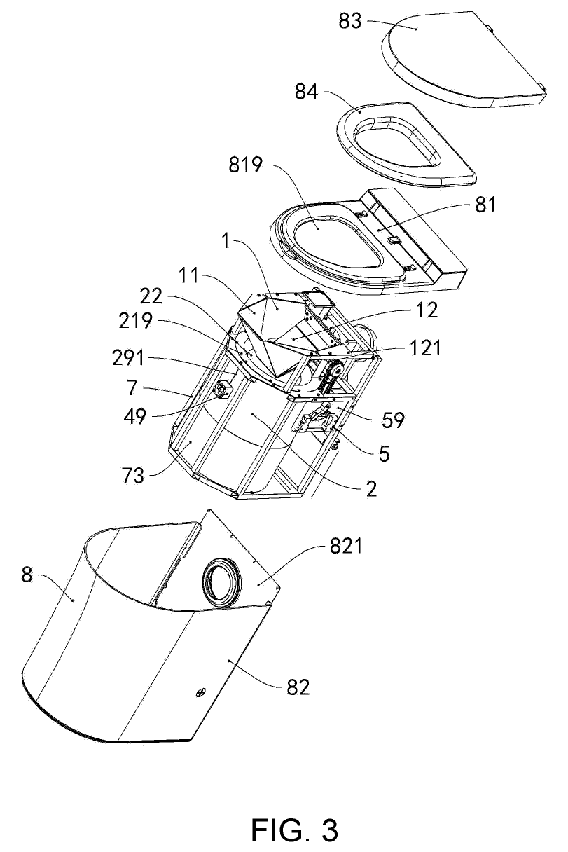

FIG. 4 is three-dimensional exploded view 3 of the incineration toilet in an embodiment of the present invention.

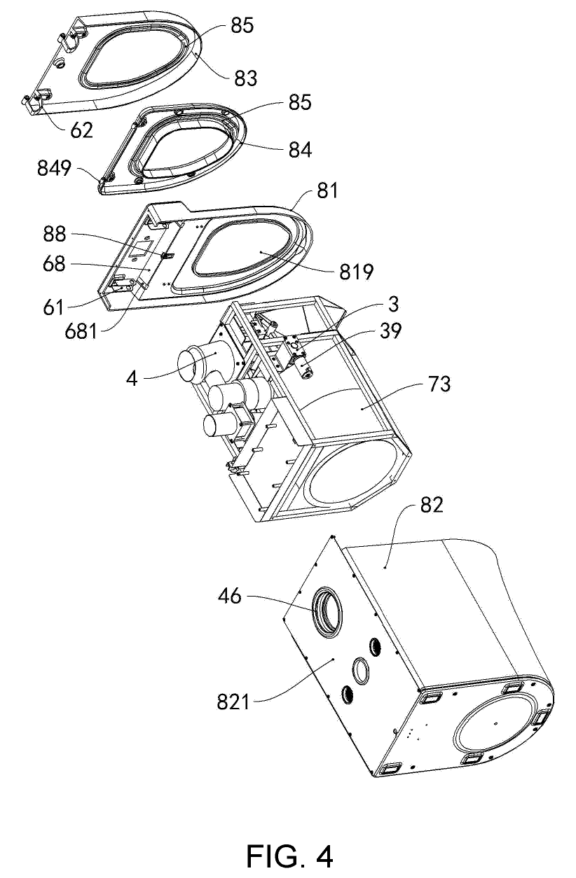

FIG. 5 is a three-dimensional schematic diagram of the buffer component 13 in an embodiment of the present invention.

FIG. 6 is a schematic diagram of the unfolded buffer component 13 in an embodiment of the present invention.

FIG. 7 is a schematic diagram of the unfolded buffer component 13 in an embodiment of the present invention; Line 1 denotes a reference straight line; LINE2 denotes an extended straight line of one side of the mounting plate 139 on the front plate 132; dot filling denotes sheet material that has been punched and removed.

FIG. 8 is a three-dimensional schematic diagram of the incineration sealing component 22 in an embodiment of the present invention.

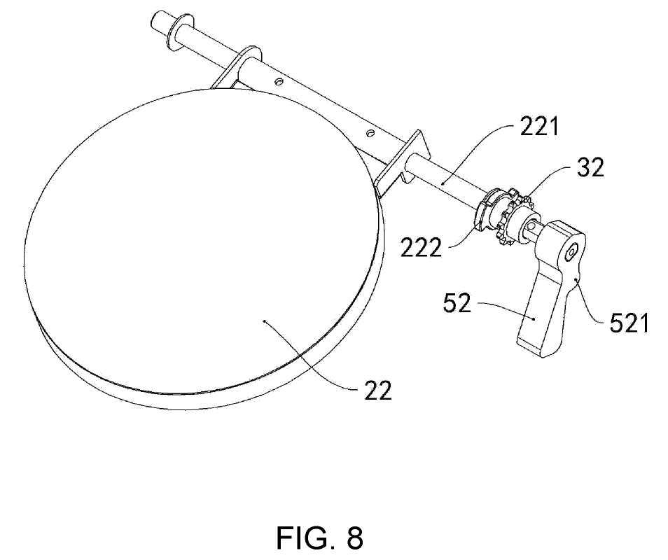

FIG. 9 is a three-dimensional exploded view of the flipping fixing component 61 and the flipping component 62 in an embodiment of the present invention.

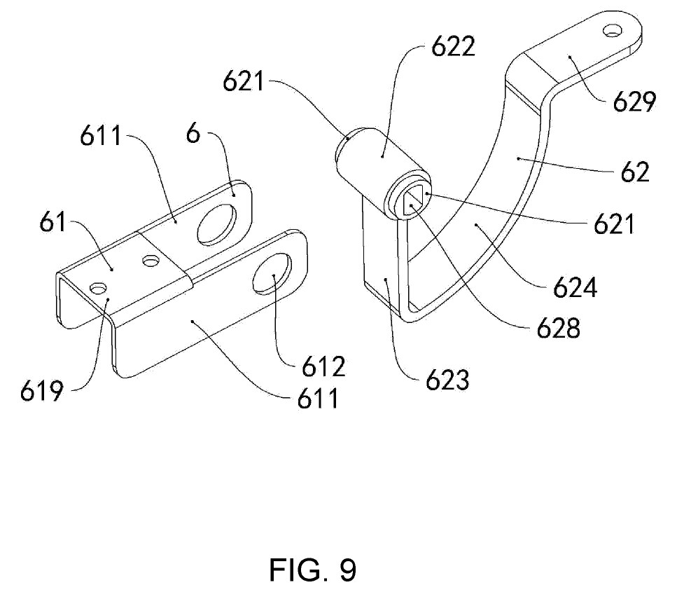

FIG. 10 is a three-dimensional schematic diagram of the bracket 7 in an embodiment of the present invention.

FIG. 11 is a top view of the bracket 7 in an embodiment of the present invention.

FIG. 12 is side view 1 of the incineration toilet in an embodiment of the present invention, where the housing assembly 8 is not shown.

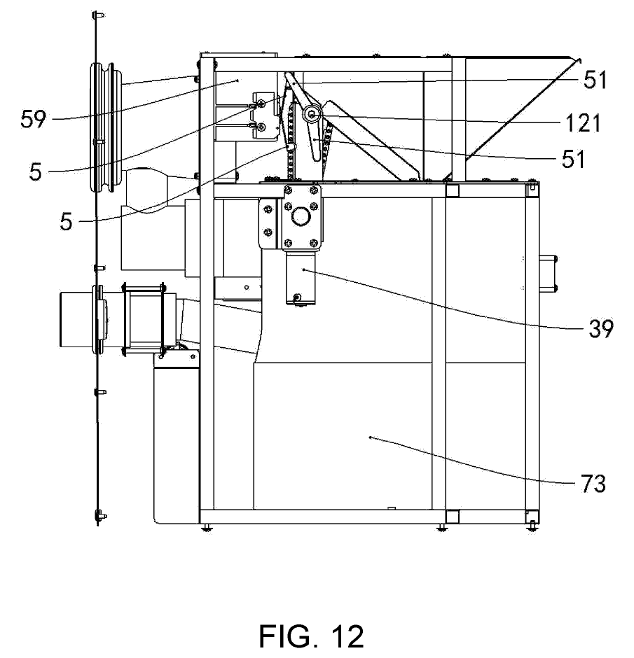

FIG. 13 is side view 2 of the incineration toilet in an embodiment of the present invention, where the housing assembly 8 is not shown.

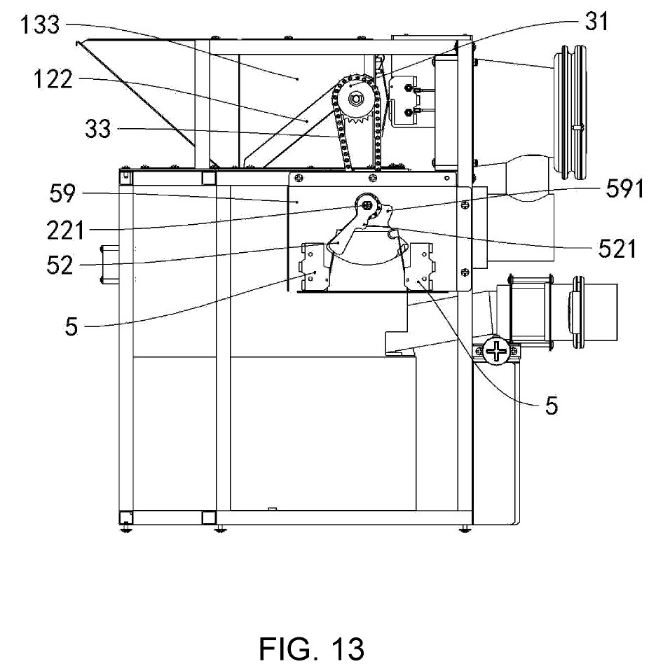

FIG. 14 is a partial three-dimensional schematic diagram of the incineration toilet in an embodiment of the present invention, where the movable cover 83 is open.

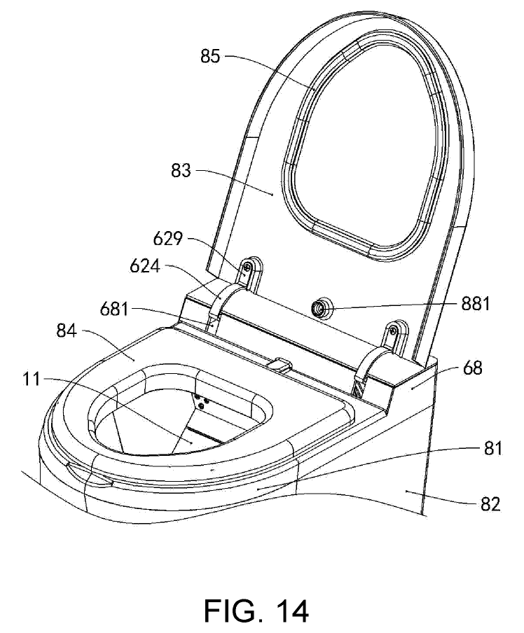

FIG. 15 is a top view of the incineration toilet in an embodiment of the present invention, where the housing top cover 81, side housing 82, and movable cover 83 are not shown.

FIG. 16 is a schematic diagram of Section 1, where the movable cover 83 is open.

FIG. 17 is a schematic diagram of Section 1, where the movable cover 83 is closed.

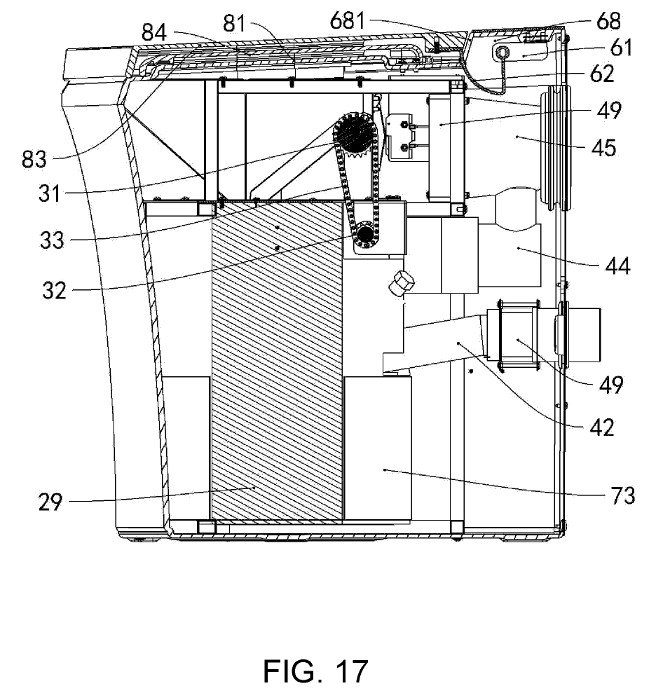

FIG. 18 is a schematic diagram of Section 2; both the release component 12 and the incineration sealing component 22 are open; Arrow 1 denotes the falling direction of the excreta; Line 3 denotes the vertical plane passing through the other end of the release component 12.

FIG. 19 is a schematic diagram of Section 2, where both the release component 12 and the incineration sealing component 22 are closed; Arrow 2 denotes the discharge direction of the excreta dust; Arrow 3 denotes the direction in which air is blown toward the incineration section 213 to make the excreta dust fly; Arrow 4 denotes the discharge direction of air from the incineration bucket 21; Arrow 5 denotes the discharge direction of air from the housing assembly 8.

FIG. 20 is a schematic diagram of Detail 1.

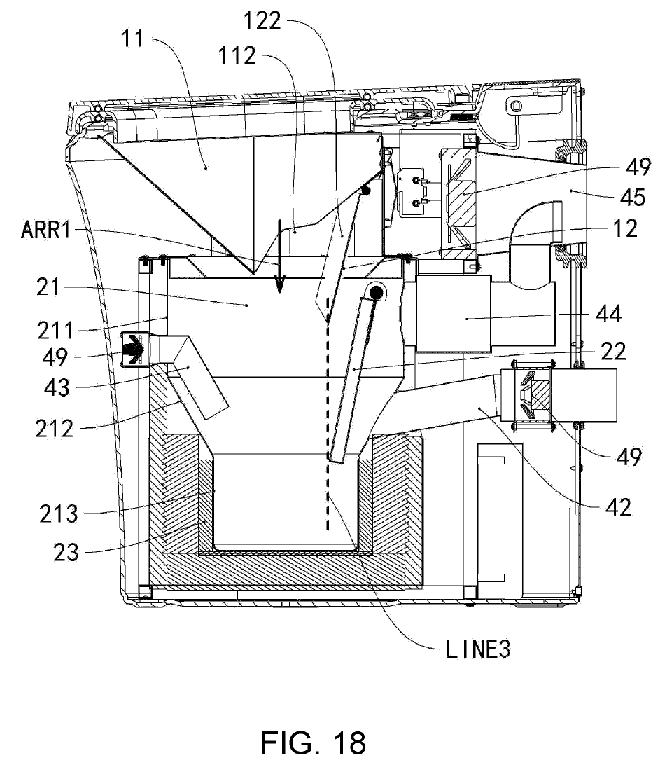

FIG. 18 in the attached drawings of the specification is designated as the attached drawing of the abstract.

### EMBODIMENTS

Specific embodiments of the present invention are to be described below by reference to the attached drawings of the specification.

As a specific embodiment, the incineration toilet of the present invention comprises at least a buffer structure 1, an incinerating structure 2, and a bracket 7.

The buffer structure 1 comprises a release component 12 and a buffer component 13, and the buffer component 13 is provided with a buffer tank 11 and a release port 111.

The incineration structure 2 comprises an incineration sealing component 22 and an incineration bucket 21 with a top opening, and a receiving section 211 is provided on the top of the incineration bucket 21. It is easy to understand that the top opening of the incineration bucket 21 is also the top opening of the receiving section 211.

Both the buffer component 13 and the incineration bucket 21 are provided on the bracket 7. Usually, both the buffer component 13 and the incineration bucket 21 are fixed to the bracket 7; usually, the buffer component 13 and the incineration bucket 21 are detachably provided on the bracket 7 using screws, etc.

When viewed from above, the release port 111 partly overlaps with the top opening of the incineration bucket 21. Usually, the release port 111 is directly aligned with the top opening of the incineration bucket 21.

The release component 12 is hinged to the buffer component 13 and fully covers the release port 111. The two sides of the release component 12 extend to form release component side walls 122, which fit the outer wall of the buffer component 13, not only improving sealing performance but also facilitating the guidance and limiting of excreta.

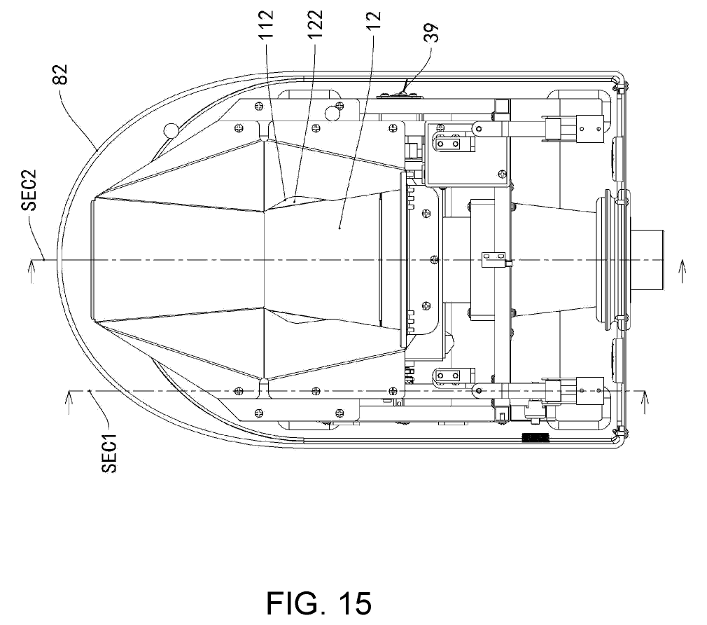

As shown in FIG. 15, the bottom end of the release port 111 is provided with a transverse notch 112; when viewed from above, it is completely located within the top opening of the incineration bucket 21. When viewed from above, the transverse notch 112 is an obtuse triangle, and the obtuse angle of which is the angle on the side away from the release component 12. Usually, the obtuse angle of this obtuse triangle is filleted. This ensures that excreta, etc. fall onto the wax paper 9 of the release component 12; and when the release component 12 rotates to open, the transverse notch 112 also ensures that the wax paper 9 and the excreta thereon move downward through the transverse notch 112 and into the top opening of the incineration bucket 21, thereby improving reliability.

The incineration sealing component 22 is hinged to the incineration bucket 21 and fully covers the top opening of the incineration bucket 21. The incineration sealing component 22 is made of metal and filled with a conventional thermal insulation material.

The incineration bucket 21 also comprises an incineration section 213 located below the receiving section 211. The incineration section 213 is provided with a heating component 23, and thus has the heating function.

Both the release component 12 and the incineration sealing component 22 have rotational power.

The working principle is as follows: Before use, the wax paper 9 is laid above the buffer structure 1, and part of the wax paper 9 is located within the buffer tank 11. It is easy to understand that part of the wax paper 9 is located above the buffer tank 11 and is fixed (the fixing method of the wax paper 9 will be described later).

When the toilet user uses the toilet, its excreta falls onto the wax paper 9 in the buffer tank 11. At this point, the release component 12 completely blocks the release port 111 and is closed, and the incineration sealing component 22 completely blocks the top opening of the incineration bucket 21 and is closed.

When the toilet user is to clean the toilet after use, the release component 12 and the incineration sealing component 22 are both controlled to rotate to open, and the excreta and the wax paper 9 slide off the release component 12, pass through the release port 111, fall into the incineration bucket 21 from the top opening of the incineration bucket 21, and enter the incineration section 213. Then, the heating component 23 is turned on to a sufficiently high temperature, so that the wax paper 9 and the excreta thereon are burned into ash, thus reducing odor, facilitating cleaning, saving water and energy, protecting the environment, and ensuring hygiene and safety.

The trajectory formed by the rotation of the other end of the release component 12 (other than the end of the release component 12 hinged to the bracket 7) exists in a part lower than the top of the incineration bucket 21. It is easy to understand that, as shown in FIG. 18, the trajectory formed by the rotation of the other end of the release component 12 is a circular arc, and the lower part of this circular arc line is lower than the top of the incineration bucket 21. After the release component 12 rotates to open, the other end of the release component 12 is inserted into the top opening of the incineration bucket 21.

As a specific embodiment, it further comprises a rotational power device 39, which is a device capable of providing rotational power, such as a reducing motor. The release component 12 is fixedly provided with a release component shaft 121, which is hinged to the bracket 7 through a bearing, etc. to become rotatable. The incineration sealing component 22 is lower than the top of the incineration bucket 21, so that the incineration sealing component 22 is located inside the incineration bucket 21. The incineration sealing component shaft 221 passes through the incineration bucket 21 snugly and is hinged to the bracket 7 through a bearing, thereby hinging the incineration sealing component 22 to the incineration bucket 21. It is easy to understand that the incineration sealing component 22 can thus rotate. The rotational output end of the rotational power device 39 is connected to at least one of the release component shaft 121 and the incineration sealing component shaft 221, so that both the release component shaft 121 and the incineration sealing component shaft 221 have rotational power. There are two layers of separation between the buffer tank 11 and the incineration bucket 21, which is conducive to keeping the buffer tank 11 clean.

As a specific embodiment, the rotational direction of the release component 12 when it is opened is the same as that of the incineration sealing component 22 when it is opened. This can reduce the probability of the wax paper 9 and the excreta thereon coming into contact with the top surface of the incineration sealing component 22.

As a specific embodiment, the power structure 3 further comprises a linkage component 33. The release component shaft 121 is fixed with a release component wheel having rotational power 31, and the incineration sealing component shaft 221 is fixed with an incineration sealing component wheel having rotational power 32. The linkage component 33 is connected to both the release component wheel 31 and the incineration sealing component wheel 32, allowing them to be linked. During rotation, the angular velocity of the release component wheel 31 is less than that of the incineration sealing component wheel 32; this linkage means that when the release component wheel 31 rotates, the ratio of the angular velocity of the incineration sealing component wheel 32 to that of the release component wheel 31 remains fixed. For example, both the release component wheel 31 and the incineration sealing component wheel 32 are sprockets, the number of teeth on the incineration sealing component wheel 32 is less than that on the release component wheel 31, the linkage component 33 is a chain that bypasses both the release component wheel 31 and the incineration sealing component wheel 32, allowing them to be linked. During rotation, the release component 12 opens and inserts into the top opening of the incineration bucket 21, and the incineration sealing component 22 rapidly rotates to open, allowing the top opening of the incineration bucket 21 to be opened. This process is stable and reliable due to linkage, so that the distance between the bottom end of the release component 12 and the top end of the incineration bucket 21 can be set very small or even zero, which can reduce the overall height of the toilet and achieve miniaturization.

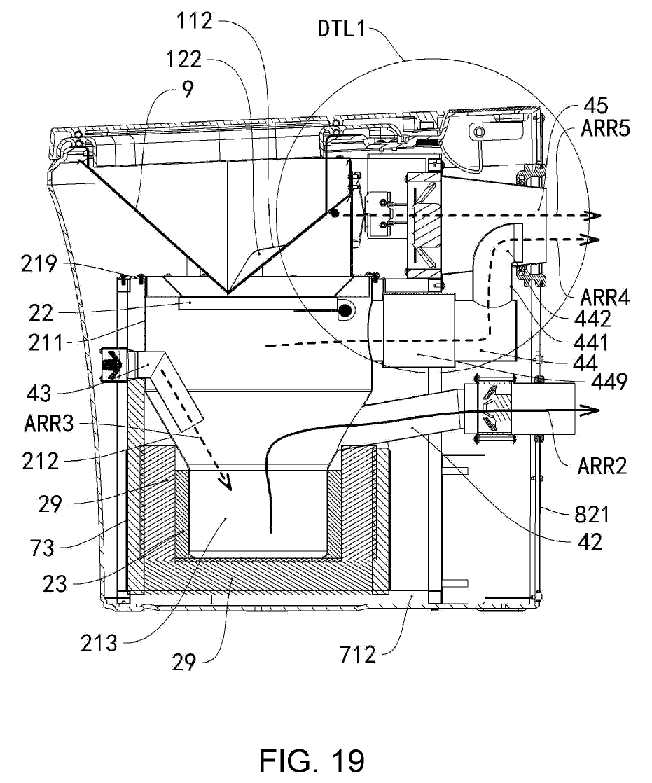

As a specific embodiment, as shown in FIG. 19, when both the release component 12 and the incineration sealing component 22 are sealed, the release component 12 is arranged to tilt downward (i.e., the other end of the release component 12 is lower than the end where it is hinged to the bracket 7), and the incineration sealing component 22 is arranged horizontally. During the rotation and opening of the release component 12, the wax paper 9, the excreta thereon, etc. slide down under the guiding action of the release component 12. The wax paper 9, the excreta thereon, etc. have a horizontal motion vector, thereby reducing the probability of the wax paper 9, the excreta thereon, etc. coming into contact with the top surface of the incineration sealing component 22.

As a specific embodiment, as shown in Line 3 of FIG. 18, when the incineration sealing component 22 rotates to open to press against the inner wall of the incineration bucket 21, the release component 12 is set to tilt downward, and the incineration sealing component 22 is completely located inside the vertical plane passing through the other end of the release component 12 (i.e., the right side as shown in FIG. 18). Even if the release component 12 rotates to open completely, the wax paper 9, the excreta thereon, etc. will only fall off, but will not come into contact with the top surface of the incineration sealing component 22, thus preventing the wax paper 9, the excreta thereon, etc. from coming into contact with the top surface of the incineration sealing component 22, and keeping the top surface of the incineration sealing component 22 clean.

The incineration toilet in an embodiment of the present invention further comprises an exhaust structure 4, which comprises a dust discharge pipe having air circulation power 42. Such air circulation power, and other air circulation power refers to the power directed from the inlet to the outlet of the pipe. For example, a fan 49 is arranged in the middle of the pipe, and is an axial fan that provides the air inside the pipe with the power to flow from the inlet to the outlet of the pipe. The inlet end of the dust discharge pipe 42 is connected to the incineration bucket 21, and the outlet end of the dust discharge pipe 42 is connected to the outside, which refers to the outside of the incineration toilet; for any embodiment with an housing assembly 8, the outside refers to the outside of the housing assembly 8.

As a specific embodiment, a transition section 212 is arranged between the receiving section 211 and the incineration section 213. The cross-sectional area of the top inner cavity of the transition section 212 (communicating with the receiving section 211) is smaller than of the bottom inner cavity of the transition section 212 (communicating with the incineration section 213). The inner cavity of the transition section 212 is usually a frustum in shape. While ensuring that the wax paper 9, excreta, etc. in the buffer tank 11 fall into the receiving section 211 easily, it can gather the wax paper 9, excreta, etc. that fall into the incineration section 213 for incineration within the incineration section 213.

As a specific embodiment, the outlet end of the dust discharge pipe 42 is connected to an ash water tank (not shown in the attached drawings). The ash water tank is a container for holding still or flowing water. The water in the ash water tank can absorb dust formed by the combustion of the wax paper 9, excreta, etc. discharged from the dust discharge pipe 42, thereby keeping the air clean.

As a specific embodiment, the exhaust structure 4 further comprises a dust blowing pipe having air circulation power 43. The inlet end of the dust blowing pipe 43 is connected to the incineration bucket 21, and the outlet end of the dust blowing pipe 43 is connected to the outside. As shown in FIG. 19, the outlet end of the dust discharge pipe 42 and the outlet end of the dust blowing pipe 43 are arranged on the left and right sides of the incineration bucket 21, respectively. The air outputted from the dust blowing pipe 43 can blow up the dust formed by the combustion of the wax paper 9, excreta, etc. in the incineration section 213, and then discharge it through the dust discharge pipe 42, thereby improving the cleanliness of the incineration section 213.

As a specific embodiment, the dust blowing pipe 43 is connected to the transition section 212, and its outlet is parallel to the side wall of the transition section 212. This ensures that the dust blown out from the dust blowing pipe 43 is directed toward the incineration section 213, thereby ensuring that the dust formed by the combustion of the wax paper 9, excreta, etc. is blown up.

As a specific embodiment, the exhaust structure 4 further comprises an odor discharge pipe 44, where the inlet end of the odor discharge pipe 44 is connected to the incineration bucket 21, and the outlet end of the odor discharge pipe 44 (i.e., the odor discharge outlet 441) is connected to the outside. The inlet end of the odor discharge pipe 44 is located above the inlet end of the dust discharge pipe 42, and the outlet end of the odor discharge pipe 44 is provided with an odor discharge bend 442 extending into the inner cavity pipe 45. When air flows inside the inner cavity pipe 45, negative pressure is formed inside the odor discharge pipe 44, thereby enabling the continuous extraction of air from the odor discharge pipe 44. The wax paper 9, excreta, etc. burned in the incineration bucket 21 form heavy dust that settles downward, while the odorous gas above the incineration bucket 21 is discharged through the odor discharge pipe 44, reducing the odorous gas escaping from the incineration bucket 21. As shown in FIG. 18, the end of the odor discharge bend 442 is roughly parallel to the axis of the inner cavity pipe 45. However, as another embodiment (not shown in the figure), the end axis of the odor discharge bend 442 is roughly perpendicular to the axis of the inner cavity pipe 45, and the end of the inner cavity pipe 45 and the odor discharge bend 442 are arranged in a T shape to form a venturi structure, which can improve the air flow efficiency of the odor discharge pipe 44, but the assembly between the odor discharge pipe 44 and the inner cavity pipe 45 is relatively difficult.

As a specific embodiment, as shown in FIG. 18, when the incineration sealing component 22 rotates to open, it blocks the inlet end of the odor discharge pipe 44. In other words, when viewed along the inlet end of the odor discharge pipe 44, the inlet end of the odor discharge pipe 44 is completely located inside the incineration sealing component 22. This can partly prevent the wax paper 9, the excreta thereon, etc. from falling into the inlet end of the odor discharge pipe 44 when they fall from the buffer tank 11.

As a specific embodiment, the odor discharge pipe 44 is also provided with a filtering device 449, which is a conventional filter material such as filter cotton, used to filter out dust, odor components, etc. formed by the combustion of the wax paper 9, excreta, etc., and can reduce the odor of the air discharged from the odor discharge pipe 44.

The incineration toilet in an embodiment of the present invention further comprises a housing assembly 8. The buffer structure 1, the incinerating structure 2, and the bracket 7 are all provided within the housing assembly 8. The exhaust structure 4 further comprises an inner cavity pipe having air circulation power 45. The inlet end of the inner cavity pipe 45 is connected to the inner cavity of the housing assembly 8, and the outlet end of the inner cavity pipe 45 is connected to the outside. This allows the air within the housing assembly 8 to flow, achieving heat dissipation and odor dispersion. The housing assembly 8 is provided with vent holes 829 to allow outside air to enter the inner cavity of the housing assembly 8.

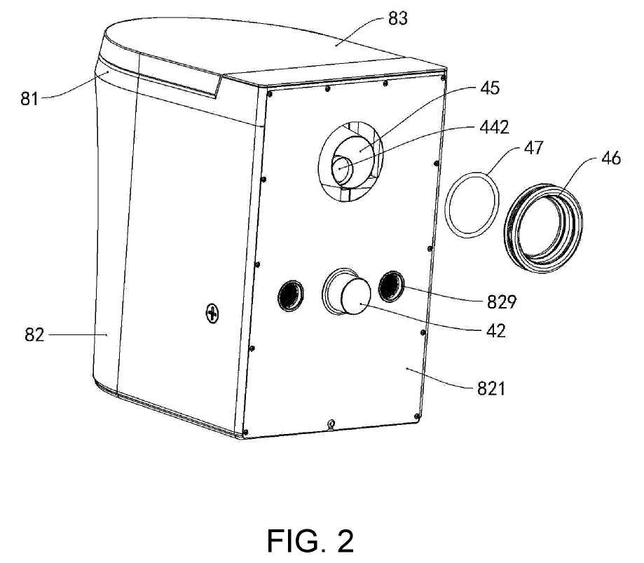

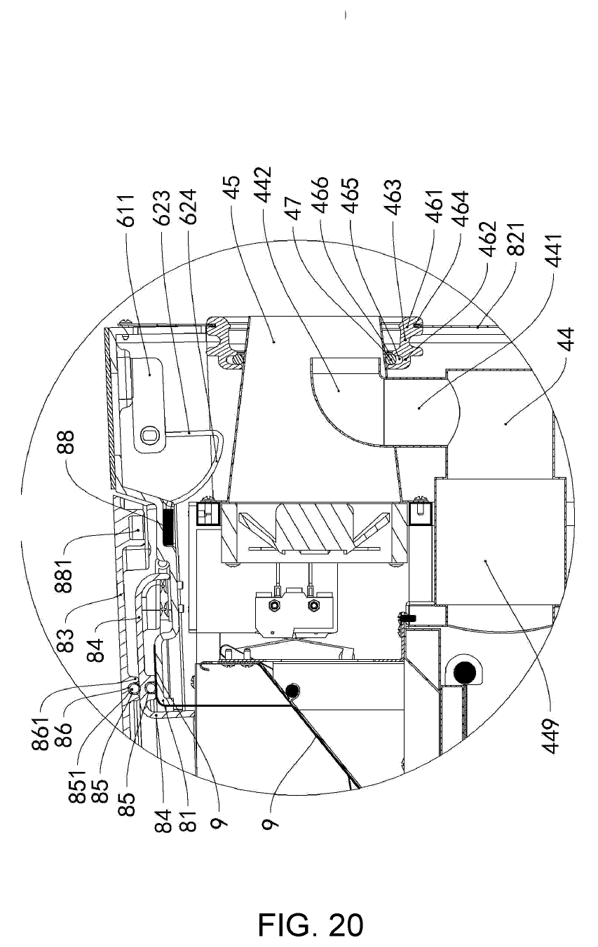

As shown in FIG. 2 and FIG. 20, as a specific embodiment, the exhaust structure 4 further comprises an elastic inner cavity pipe fastener 46. For example, the inner cavity pipe fastener 46 is made of rubber, silicone, etc., and is therefore flexible. The inner cavity pipe fastener 46 is annular, which refers to the shape formed by a sealed pattern rotating around an axis, such as the cylinder formed by a rectangle rotating around one of its sides, or the frustum formed by a right-angled trapezoid rotating around its right-angled side. The housing assembly 8 comprises a plate-shaped back plate 821; the cross section of the outer wall of the inner cavity pipe 45 is all frustum-shaped; the inner cavity pipe fastener 46 comprises a plate connection end 461 and a pipe connection end 462, where the plate connection end 461 is fixedly connected to the back plate 821, and the pipe connection end 462 presses against the inner cavity pipe 45 directly or indirectly, thereby facilitating the installation of the inner cavity pipe 45 and providing good sealing performance.

As a specific embodiment, the plate connection end 461 is provided with a plate groove 464, into which the back plate 821 is inserted, thereby achieving a fixed connection between the plate connection end 461 and the back plate 821. Of course, the plate connection end 461 can also be fixedly connected to the back plate 821 by means such as glue bonding or screw fastening. However, the embodiment where the back plate 821 is inserted into the plate groove 464 facilitates the fixed connection between the plate connection end 461 and the back plate 821.

As a specific embodiment, the inner cavity pipe sealing ring 47 is annular and has a circular cross section. The pipe connecting end 462 is provided with a ring groove 465, and the inner cavity pipe sealing ring 47 is fitted snugly over the inner cavity pipe 45 and located within the ring groove 465.

As a specific embodiment, the groove width of the ring groove 465 is smaller than the diameter of the cross section of the inner cavity pipe sealing ring 47. This can improve the fixation effect between the inner cavity pipe sealing ring 47 and the inner cavity pipe fastener 46.

As a specific embodiment, an outer wall opening 466 is provided on the outer side of the ring groove 465. The outer wall of the ring groove 465 is relatively short, and it presses against the inner cavity pipe sealing ring 47, so that the inner cavity pipe sealing ring 47 tends to approach the inner cavity pipe 45, thereby improving the sealing effect.

As a specific embodiment, an intermediate section 463 is provided between the plate connection end 461 and the pipe connection end 462. The thickness (the dimension in the vertical direction as shown in FIG. 20) of the intermediate section 463 is less than that of the plate connection end 461 and that of the pipe connection end 462. The plate connection end 461 and the pipe connection end 462 are opposite to each other. It is easy to understand that the plate connection end 461, the intermediate section 463, and the pipe connection end 462 form a Z shape as a whole, thereby improving the overall elasticity of the inner cavity pipe fastener 46, and sealing performance.

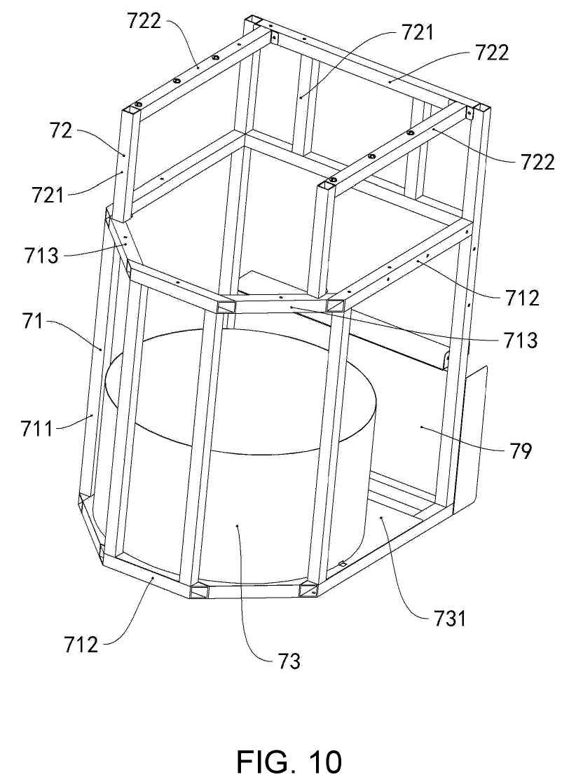

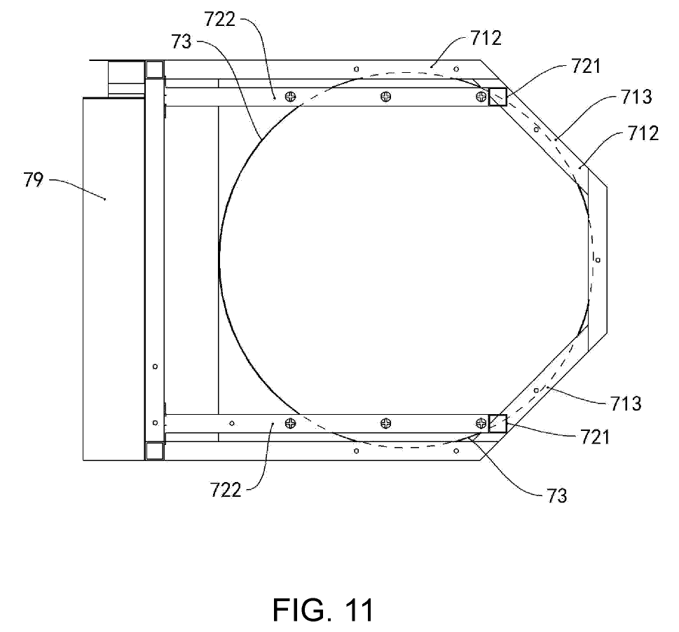

As shown in FIG. 10 and FIG. 11, for the incineration toilet in an embodiment of the present invention, the bracket 7 comprises a bottom bracket 71 and a top bracket 72; the bottom bracket 71 comprises a bottom columns 711 and horizontal frames 712; both ends of the bottom bracket 71 are fixedly connected to the uppermost and lowermost horizontal frames 712, respectively.

The top bracket 72 comprises a top column 721 and a top beam 722; the bottom end of the top column 721 is fixed to the uppermost horizontal frame 712 of the bottom bracket 71, and the top beam 722 is fixedly connected to the top end of the top column 721.

The top beam 722 is used to mount the mounting plate 139 of the buffer component 13 fixedly, and the horizontal frame 712 is used to mount the incineration bucket 21 fixedly.

As a specific embodiment, the front end of the horizontal frame 712 is provided with an oblique beam 713. The bottom end of the top column 721 of the top bracket 72 is fixed on the oblique beam 713, and when viewed from above, the top beam 722 is completely located within the horizontal frame 712, thereby ensuring the strength of the bracket 7.

As a specific embodiment, the bracket 7 further comprises an mounting cylinder 73 fixed on the lowermost horizontal frame 712 of the bottom bracket 71; for example, an mounting cylinder bottom plate 731 is fixedly provided on the lowermost horizontal frame 712 of the bottom bracket 71, and the mounting cylinder 73 is fixed on the mounting cylinder bottom plate 731, so that the incineration bucket 21 can be installed inside the mounting cylinder 73 easily.

As shown in FIG. 11, as a specific embodiment, the mounting cylinder 73 partly overlaps with the horizontal frame 712 when viewed from above. As shown in FIG. 10, the top of the mounting cylinder 73 is lower than the uppermost horizontal frame 712 of the bottom bracket 71, thereby utilizing space effectively and facilitating miniaturization.

As a specific embodiment, a heat insulation layer 29 is provided inside the mounting cylinder 73, and provided with vertical expansion joints 291. After the incineration bucket 21 is placed into the heat insulation layer 29 from its top, the heat insulation layer 29 is slightly opened, ensuring that both the incineration bucket 21 and the heat insulation layer 29 are fixed inside the mounting cylinder 73, facilitating the installation of the incineration bucket 21.

The top of the incineration bucket 21 is provided with an incineration bucket top cover (not shown in the attached drawings), which is fixed to the uppermost horizontal frame 712 of the bottom bracket 71 via the incineration bucket top edge 219.

Usually, the bottom bracket 71 is fixedly provided with a container 79, which is used to contain devices such as circuit boards and batteries.

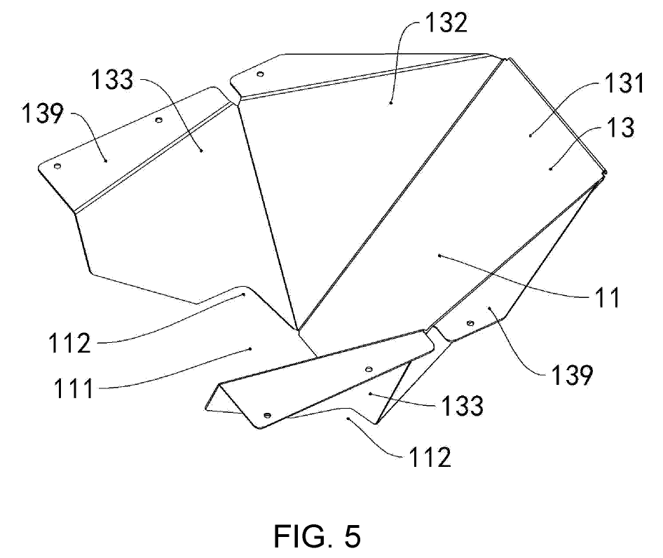

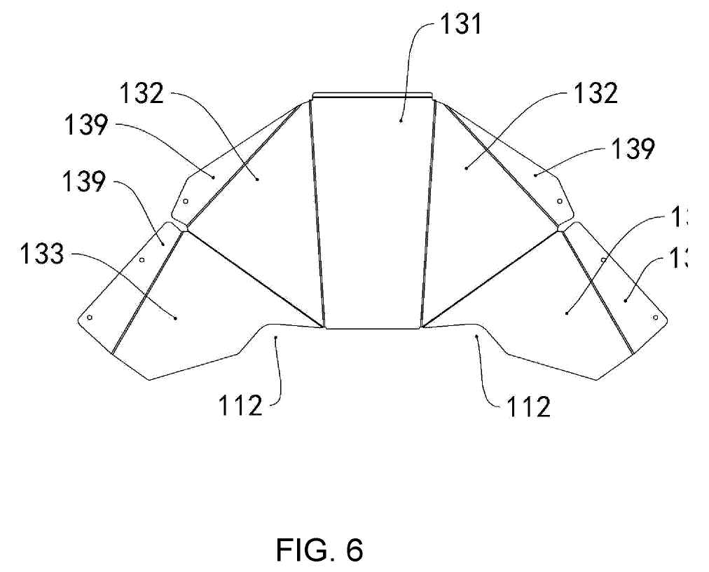

As shown in FIG. 5 to FIG. 7, the buffer component 13 is made of a sheet material, such as an iron sheet, and comprises a front plate 131 that is trapezoidal or rectangular when viewed from above. The two sides of the front plate 131 are connected with a front side plate 132 and a rear side plate 133 in sequence, respectively. The buffer component 13 can be made by punching and bending an iron sheet, etc., which facilitates the mass production of the buffer component 13 and helps reduce costs.

As a specific embodiment, both the front side plate 132 and the rear side plate 133 are connected to a mounting plate 139 on the outside. When unfolded, a process gap 138 is provided between the mounting plate 139 of the front side plate 132 and the mounting plate 139 of the rear side plate 133.

As a specific embodiment, when the buffer component 13 is unfolded, it is symmetrical about its own mirror image, and the plane of this mirror symmetry is perpendicular to the exposed edge of the front plate 131. This exposed edge refers to the edge that is not connected to the front side plate 132.

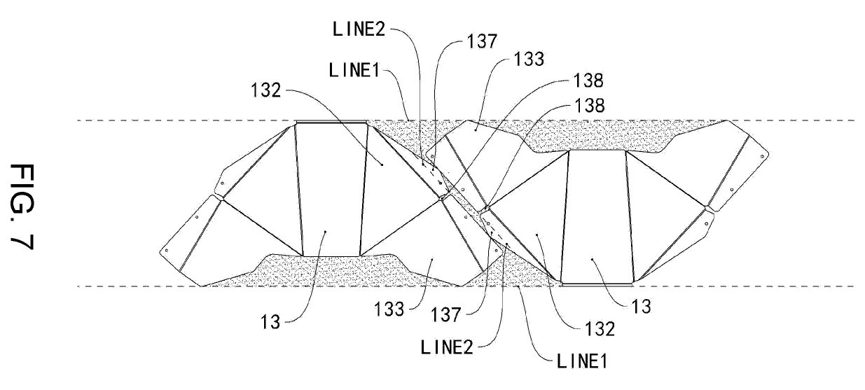

As a specific embodiment, when the buffer component 13 is unfolded, the mounting plate 139 of the front side plate 132 has a bulge 137 relative to the mounting plate 139 of the rear side plate 133. As shown in FIG. 7, after an unfolded buffer component 13 rotates by 180°, the bulge 137 of the mounting plate 139 of the front side plate 132 fits with the mounting plate 139 of the rear side plate 133 of another unfolded buffer component 13, forming an area resembling a parallelogram. This area is connected to the process gap 138 and can be formed in one punching process, which is conducive to improving the production efficiency and punching quality of the buffer component 13.

The incineration toilet in an embodiment of the present invention further comprises a flipping structure 6 and a housing assembly 8. The housing assembly 8 comprises a movable cover 83, an housing top cover 81, and a side housing 82. The housing top cover 81 is provided with an exposed opening 819. The side housing 82 is used to surround the bracket 7 and the parts thereon.

The flipping structure 6 comprises a flipping fixing component 61 and a flipping component 62. The flipping fixing component 61 comprises a hinged side wall 611 provided with a hinging hole 612. The flipping component 62 comprises a hinged body 621 and an extension segment 623 fixedly connected to the hinged body 621. The extension segment 623 is connected to an arc segment 624, and the cross section of the arc segment 624 is an annular sector in shape overall (i.e., a circular ring with a central angle of less than 360°).

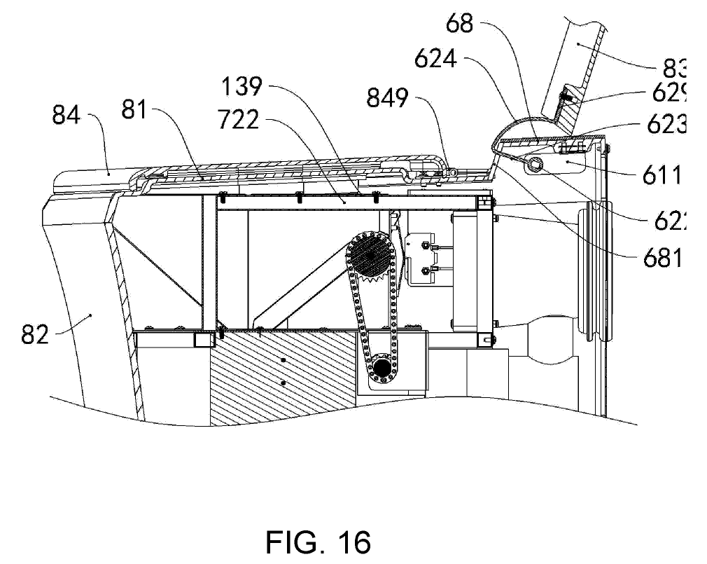

The hinge body 621 is embedded into the hinge hole 612, the flipping fixing component 61 is fixedly connected to the housing top cover 81, and one end of the arc segment 624 (the cover connecting lug 629) is fixedly connected to the movable cover 83. As shown in FIG. 16, when the movable cover 83 rotates to open, the arc segment 624 can make the movable cover 83 move backward as a whole, saving space and facilitating the use of the toilet.

As a specific embodiment, the flipping structure 6 comprises a fixing component mounting body 619, with elastic hinged side walls 611 provided on its two sides. The middle part of the hinged body 621 extends outward to form a clamped platform 622. Each of the two hinged side walls 611 tends to approach the clamped platform 622 and press against it. The hinged body 621 is embedded into the hinged hole 612, making it less prone to falling off, improving reliability, and facilitating the assembly of the flipping component 62 onto the flipping fixing component 61.

As a specific embodiment, the hinge body 621 is provided with a long functional hole 628. The output shaft of a damping device is embedded into the functional hole 628, which can achieve a damping sealing effect for the movable cover 83 together with the damping device.

As a specific embodiment, the rear end of the housing top cover 81 extends upward to form an extension platform 68, which is provided with a flipping component opening 681. The fixing component mounting body 619 is fixedly connected to the inner wall of the extension platform 68, and the extension segment 623 and the arc segment 624 can pass through the flipping component opening 681.

As a specific embodiment, when the movable cover 83 is closed, its top surface is flush with the top surface of the extension platform 68.

As a specific embodiment, the movable cover 83 is provided with a magnetic groove 881, which faces the magnetic sensor 88 when the movable cover 83 is closed. After a magnet, etc. is embedded (not shown in the figure) into the magnetic groove 881, the magnet, etc. can trigger the magnetic sensor 88 when the movable cover 83 is closed. The magnetic sensor 88 is electrically connected to the heating component 23 and/or the rotational power device 39, ensuring that the heating component 23 and/or the rotational power device 39 can only operate when the movable cover 83 is closed, thereby improving safety.

The housing assembly 8 also comprises a wax paper fastener 84 and a flexible strip 85. It is easy to understand that the flexible strip 85 is flexible, such as a rubber strip. The wax paper fastener 84 is provided with a through hole (not marked in the attached drawings), which is directly opposite to the top opening of the buffer groove 11. The flexible strip 85 is fixedly connected to the bottom end of the wax paper fastener 84 and presses against the top surface of the housing top cover 81. Although the specific shape of the wax paper 9 is not shown, it is easy to understand that the edge of the wax paper 9 is annular and used for fixation; the middle part of the wax paper 9 concaves down and roughly fits with the buffer groove 11, used to receive excreta, etc. When a person sits on the wax paper fastener 84, his/her weight causes the flexible strip 85 and the housing top cover 81 to clamp the wax paper 9, and the flexible strip 85 deforms to have a larger contact surface with the wax paper 9, improving the effect of fixing the wax paper 9.

As a specific embodiment, the bottom wall of the wax paper fastener 84 is provided with a slot 86. The flexible strip 85 is partly inserted into the slot 86, thereby fixing the flexible strip 85 to the bottom end of the wax paper fastener 84, facilitating the disassembly and assembly of the flexible strip 85.

As a specific embodiment, the side wall of the slot 86 is the slot side wall 861, and the cross section of the flexible strip 85 is circular, with a portion extending beyond the slot side wall 861 of the slot 86.

As a specific embodiment, the bottom end of the slot side wall 861 has a semicircular cross section, and presses against the wax paper 9, further improving the effect of fixing the wax paper 9.

As a specific embodiment, the flexible strip 85 is provided with a flexible strip cavity 851, improving the deformability of the flexible strip 85, facilitating the insertion of the wax paper fastener 84 into the slot 86. When the wax paper fastener 84 is pressed tightly, it has a larger contact area with the wax paper 9, thereby improving the effect of fixing the wax paper 9.

As a specific embodiment, the through hole of the wax paper fastener 84 is completely located within the flexible strip 85 when viewed from above. The flexible strip 85 surrounds the through hole of the wax paper fastener 84, thereby improving the effect of fixing the wax paper 9.

As a specific embodiment, the housing top cover 81 is provided with a hinge 849, which is connected to the wax paper fastener 84.

It should be noted that the relevant structure of the above flexible strip 85 can also be arranged at the bottom end of the movable cover 83 to improving the sealing performance when the movable cover 83 is closed. This will not be repeated below.

In addition, the flexible strip 85 of the movable cover 83 is directly opposite to the flexible strip 85 of the wax paper fixture 84, and the flexible strips 85 of the movable cover 83 and the wax paper fixture 84 can be unified, which is conducive to cost reduction.

The incineration toilet in an embodiment of the present invention further comprises a sensor 5 electrically connected to the rotary power device 39; the sensor 5 is a contact switch and is fixed on the bracket 7; the release component shaft 121 is provided with a release trigger 51, which can trigger the sensor 5 as it rotates with the release component shaft 121; the incineration sealing component shaft 221 is connected to an incineration trigger rod 52, which can trigger the sensor 5 as it rotates with the incineration sealing component shaft 221, thereby controlling the rotation angle of the release component 12 and/or the incineration sealing component 22, and ensuring sealing performance.

As a specific embodiment, the incineration trigger rod 52 is provided with a trigger rod bulge 521; when the incineration trigger rod 52 rotates, it can pass over the trigger end of the sensor 5. When the incineration trigger rod 52 rotates, it can trigger the sensor 5 for some time, achieving segmented control over the rotation of the incineration sealing component 22. For example, when the release component 12 and the incineration sealing component 22 rotate to open, they first rotate quickly to open, and then the incineration sealing component 22 slowly opens and approaches the incineration bucket 21, thereby protecting the incineration sealing component 22 from damage by pressing against the incineration bucket 21 partly while ensuring that the wax paper 9, excreta, etc. can fall into the incineration bucket 21.

As a specific embodiment, the incineration sealing component shaft 221 is fixedly provided with a limiting bulge 222, and the bracket 7 is provided with a component that can press against the limiting bulge 222, thereby limiting the rotation angle of the incineration sealing component 22, and protecting the incineration sealing component 22 from damage due to excessive rotation.

As a specific embodiment, the bracket 7 is provided with a sensor mounting plate 59, and the sensor 5 is fixed on the sensor mounting plate 59, which is provided with a clearance opening 591 for avoiding the limiting bulge 222.

1. A linkage cover structure for incineration toilets, comprising at least a buffer structure, an incineration structure, and a bracket; the buffer structure comprises a release component and a buffer component, and the buffer component is provided with a buffer tank and a release port; the incineration structure comprises an incineration sealing component and an incineration bucket with a top opening, a receiving section is provided on the top of the incineration bucket, and both the buffer component and the incineration bucket are provided on the bracket; when viewed from above, the release port partly overlaps with the top opening of the incineration bucket;
It is characterized in that the release component is hinged to the buffer component and fully covers the release port; the incineration sealing component is hinged to the incineration bucket and fully covers the top opening of the incineration bucket; the incineration bucket also comprises an incineration section located below the receiving section, and the incineration section is provided with a heating component; both the release component and the incineration sealing component have rotational power.

2. The linkage cover structure for incineration toilets according to claim 1, wherein the trajectory formed by the rotation of the other end of the release component has a portion that is lower than the top of the incineration bucket.

3. The linkage cover structure for incineration toilets according to claim 2, wherein it further comprises a rotational power device, the release component is fixedly provided with a release component shaft, and the release component shaft is hinged to the bracket; the incineration sealing component is lower than the top of the incineration bucket, so that the incineration sealing component is located inside the incineration bucket, and the incineration sealing component shaft extends out of the incineration bucket snugly and is hinged to the bracket, and the rotational output end of the rotational power device is connected to at least one of the release component shaft and the incineration sealing component shaft.

4. The linkage cover structure for incineration toilets according to claim 3, wherein the rotational direction of the release component when it is opened is the same as that of the incineration sealing component when it is opened.

5. The linkage cover structure for incineration toilets according to claim 4, wherein the power structure further comprises a linkage component, a release component shaft is fixed with a release component wheel having rotational power, the incineration sealing component shaft is fixed with an incineration sealing component wheel having rotational power, and the linkage component is connected to the release component wheel and the incineration sealing component wheel respectively, so that the release component wheel and the incineration sealing component wheel are linked, and the angular velocity of the release component wheel is less than that of the incineration sealing component wheel during rotation.

6. The linkage cover structure for incineration toilets according to claim 5, wherein both the release component wheel and the incineration sealing component wheel are chain wheels, the number of teeth of the incineration sealing component wheel is less than that of the release component wheel, and the linkage component is a chain that bypasses both the release component wheel and the incineration sealing component wheel.

7. The linkage cover structure for incineration toilets according to claim 4, wherein when both the release component and the incineration sealing component are sealed, the release component is arranged to tilt downward, and the incineration sealing component is arranged horizontally.

8. The linkage cover structure for incineration toilets according to claim 4, wherein when the incineration sealing component member rotates to open to press against the inner wall of the incineration bucket, the release component is arranged to tilt downward, and the incineration sealing component member is completely located inside a vertical plane passing through the other end of the release component.
